(19) United States
(12) Patent Application Publication
(10) Pub. No.: US 2015/0020652 A1
(43) Pub. Date: Jan. 22, 2015

(54) Tool Bit Having Improved Removability

(71) Applicant: Klein Tools, Inc., Lincolnshire, IL (US)

(72) Inventor: Kingston Wong, Beach Park, IL (US)

(21) Appl. No.: 13/945,021

(22) Filed: Jul. 18, 2013

(51) Int. Cl. B25B 15/00

(52) U.S. Cl. CPC B25B 15/004
USPC 81/438

(57) ABSTRACT

A tool bit having a shank having a hexagonal cross-section adapted to be removably positioned within a tool for rotating the shank, a first circular section extending from a first end of the shank, an exposed circumferential groove positioned adjacent the first circular section, a second circular section having an outer surface extending from the circumferential groove, a first bit end extending from the second circular section, wherein a right angle is formed at the transition of the circumferential groove to the outer surface of the second circular section forming a first transverse gripping wall that is perpendicular to a longitudinal axis of the shank.

### BACKGROUND

The present application generally relates to removable tool bits, such as the tool bits used in a multi-purpose tool holder that may be driven by hand, or driven by a standard rotary power tool such as a handheld drill. More particularly, the present application relates to a tool bit, or reversible tool bit, having improved removability, i.e., a tool bit that is easier to remove than conventional tool bits or reversible tool bits.

Professional tradesmen, repairmen, technicians, and others are frequently required to carry a variety of tools for the various tasks that they are required to perform. As an example, tradesmen often carry both Phillips head and flat head screwdrivers. Depending on the application, different sized Phillips head or flat head screwdrivers may even be required. Additionally, other types of tools including Torx head drivers and square head drivers may be required for various applications.

As a result, multi-purpose tool holders have been developed that accept removable tool bits, such as various sized Phillips head and flat head tool bits, as well as various sized Torx and square head tool bits. In addition, to provide increased functionality, multi-purpose tool holders have been developed that accept reversible tool bits, where there is a different tool portion on each end of the reversible tool bit. For example, one end of the reversible bit may have a Phillips head tool portion, whereas the other end of the reversible bit may have a flat head tool portion. An example of a multi-purpose tool holder that is designed to accept both conventional single ended bits and reversible bits is disclosed in pending U.S. patent application Ser. No. 13/739,942 entitled “Multi-Bit Tool Driver” that was filed on Jan. 11, 2013 and assigned to Klein Tools, Inc.

In order to allow for the exchange of one tool bit for another, as circumstances may dictate, the tool bits need to be securely held within the tool holder during a driving operation, yet not be held too tightly so that the bits may be removed and exchanged for a different tool bit. Various methods have been used to removably secure a tool bit within a tool holder, including the use of detent mechanisms, springs, ball and groove designs, and press fit as examples.

The tool bits need to be removably secured within the tool holder so that a tradesman or technician can remove the bit with his/her fingers, when exchanging one tool bit for another tool bit. In practice, tool bits have proven to be difficult to remove in some instances, which may result in frustration for the user and make the bit removal process time-consuming. The problem of overly-difficult to remove bits can be exacerbated when the user has slippery fingers which may occur when grease or oil, which may be encountered in the field, adheres to the fingers and/or thumb of the user.

In view of the difficulty of removing tool bits from a tool holder that may be encountered, it would desirable to provide a tool bit, or reversible tool bit, that has improved removability. Thus, it would be desirable to provide a tool bit, or reversible tool bit, that includes a feature that improves the ability of a user to remove a tool bit from the tool holder when changing the tool bit in the tool holder.

### SUMMARY

In one aspect, a tool bit is provided having a shank having a hexagonal cross-section adapted to be removably positioned within a tool for rotating the shank, the shank having a thickness Dl, a first circular section extending from a first end of the shank, the first circular section having a diameter D2, where D2 is less than D1, an exposed circumferential groove positioned adjacent the first circular section, where the exposed circumferential groove has a diameter D3 which is less than diameter D2, a second circular section having an outer surface extending from the circumferential groove, a first bit end extending from the second circular section, and wherein a right angle is formed at the transition of the circumferential groove to the outer surface of the second circular section forming a first transverse gripping wall that is perpendicular to a longitudinal axis of the shank.

The tool bit may optionally further include a first downwardly extending finger stop positioned between the first end of the shank and the first circular section, wherein the first transverse gripping wall is positioned a distance d2 from the end of the first finger stop, where the distance d2 may optionally be ⅛ of an inch.

The tool bit may further optionally include a third circular section extending from a second end of the shank, the third circular section having a diameter D4, where D4 is less than D1, a second exposed circumferential groove positioned adjacent the third circular section, where the exposed circumferential groove has a diameter D3 which is less than diameter D4, a fourth circular section having an outer surface extending from the second circumferential groove, a second bit end extending from the fourth circular section, and wherein a right angle is formed at the transition of the second circumferential groove to the outer surface of the fourth circular section forming a second transverse gripping wall that is perpendicular to a longitudinal axis of the shank.

In a further aspect, a tool bit is provided having a shank having a hexagonal cross-section adapted to be removably positioned within a tool for rotating the shank, the shank having a thickness D1, a first circular section extending from a first end of the shank, the first circular section having a diameter D2, where D2 is less than D1, a second circular section extending from the first circular section, the second circular section having a diameter D3, where D3 is less than D1 and greater than D2, a first bit end extending from the second circular section, and wherein a right angle is formed at the transition of the first circular surface and the second circular surface forming a first transverse gripping wall that is perpendicular to a longitudinal axis of the shank.

### BRIEF DESCRIPTION OF THE DRAWINGS

Exemplary embodiments of the invention are described herein with reference to the drawings, wherein like parts are designated by like reference numerals, and wherein:

FIG. 1 is a perspective view of reversible tool bit 10;

FIG. 2 is a perspective view of reversible tool bit 10 shown in FIG. 1 positioned in tool holder 42 that extends from handle 40;

FIG. 3 is an exploded view of the reversible tool bit 10 shown in FIGS. 1 and 2, shown removed from tool holder 42 that extends from handle 40;

FIG. 4 is a side view of reversible bit 10 shown in FIGS. 1-3, with tool holder 42 and handle 40 shown in phantom lines;

FIG. 5 is a close up view of circle 5 shown in FIG. 4;

FIG. 6 is a side view of a reversible bit;

FIG. 7 is a close up view of circle 7 shown in FIG. 6;

FIG. 8 is a close up view of circle 8 shown in FIG. 6; and

FIG. 9 is a side view of a bit showing the fingertip 90 of a user contacting finger stop 62 of the bit and an end 92 of the fingertip 90 in engagement with transverse gripping wall 66a, and an end of a thumb of a user contacting finger stop 62 and in engagement with transverse gripping wall 66a.

### DETAILED DESCRIPTION

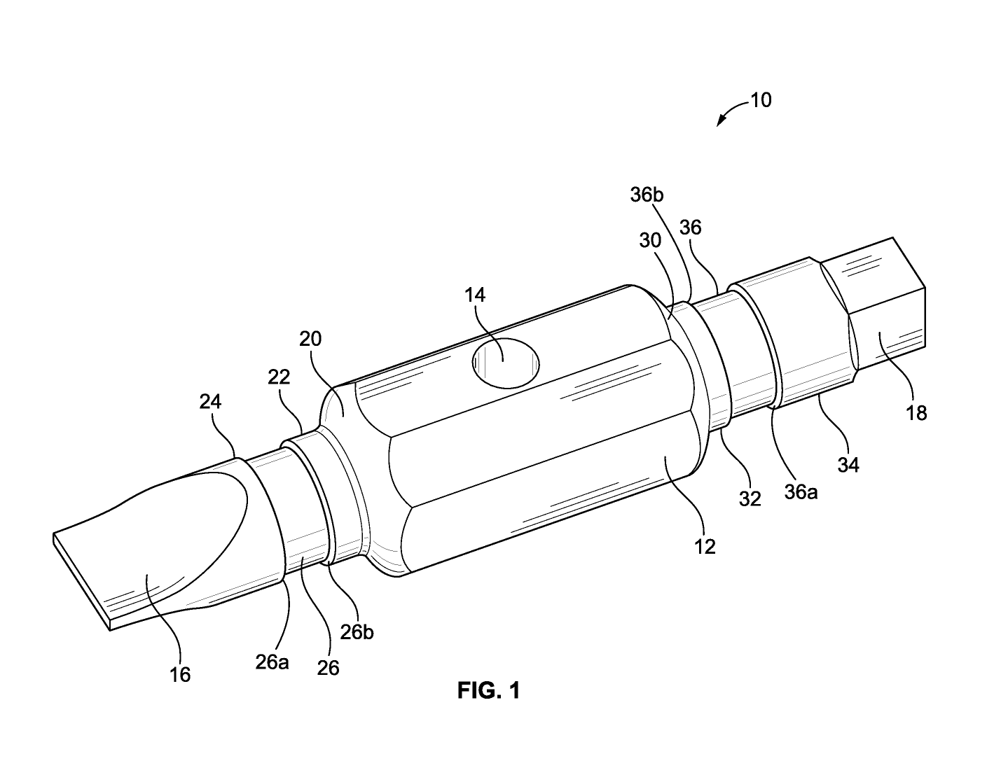

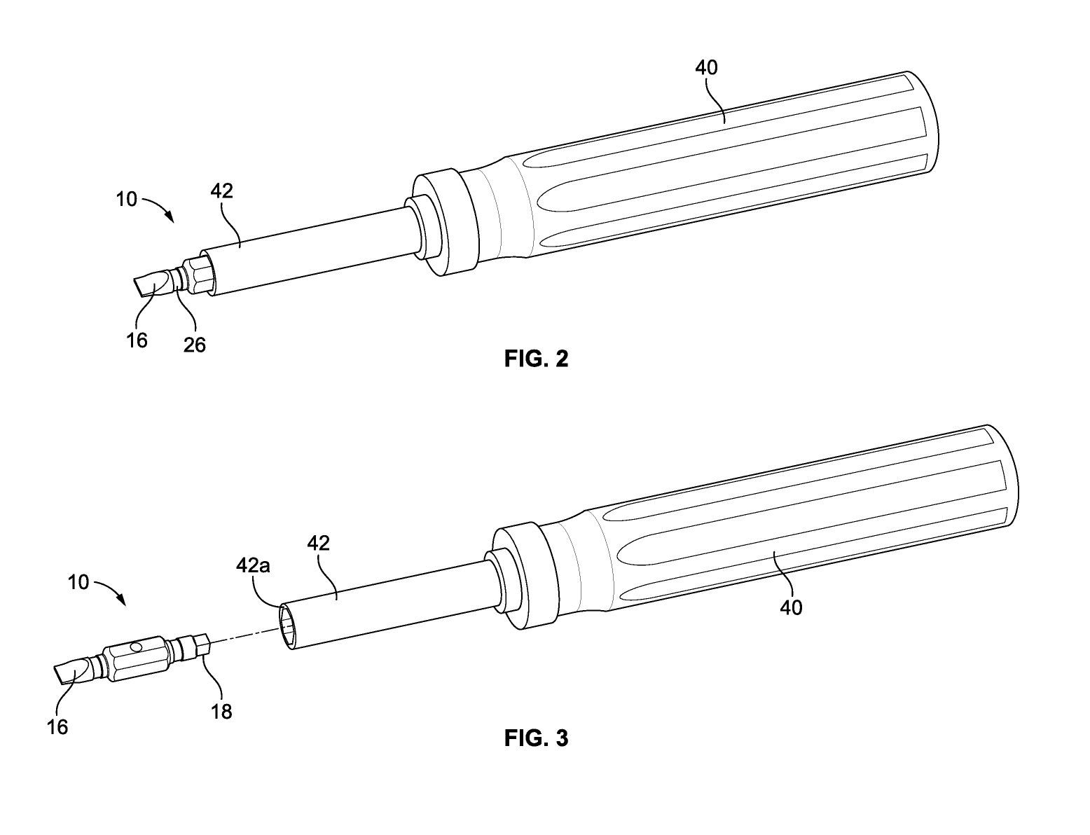

FIG. 1 is a perspective view of a reversible bit 10. Reversible bit 10 includes a hexagonal shaft 12 and a first bit end 16 extending from a first end of the shaft 12 and a second bit end 18 extending from a second end of shaft 12. Reversible bit 10 is adapted to be removably secured within a tool holder, such as a handheld tool, or a rotary power tool such as a handheld drill. Shank 12 may be adapted to be removably secured within a tool holder (see FIGS. 2 and 3). For example, a spring loaded detent 14 may be positioned on the shank 14 that applies a force against an inner wall of a tool holder that operates so that the shank 12 of reversible bit 10 may be removably secured within the tool holder. Alternately, a spring loaded detent mechanism could be positioned within the tool holder and press against the shaft 12 of reversible bit 10, or fit within a recess in the shaft 12.

Other means for removably securing the shaft 12 within a tool holder may also be used. For example, detent mechanisms, springs, ball and groove designs, magnets, press fit, or a combination thereof could be used, as examples. Moreover, the embodiments shown in the Figures are directed to a reversible bit. However, the features may be used on a non-reversible bit or singled-ended bit as well, and the disclosure and claims herein are not limited to reversible bits.

As shown in FIG. 1, a first bit end 16 extends from a first end of reversible bit 10. In this embodiment, first bit end 16 is a slotted head suitable for turning a screw. A second bit end 18 extends from a second end of reversible bit 10. In this embodiment, the second bit end is a square head driver. Any number of different bit ends may be used, such as various sized Phillips head, Torx head, and nut drivers as examples. A sloped section 20 extends between shank 12 and a first circular section 22. An exposed circumferential groove 26 is positioned adjacent the first circular section 22. Further, a second circular section 24 extends from the exposed circumferential groove 26, and bit end 16 extends from the second circular section 24. In this embodiment, the exposed circumferential groove 26 has a first wall 26b formed at the intersection between the first circular section 22 and the exposed circumferential groove 26. The exposed circumferential groove has a second wall 26a formed at the intersection between the exposed circumferential groove 26 and the second circular section 22.

The second wall 26a is formed at the transition of the exposed circumferential groove 26 to the outer surface of the second circular section 22, and second wall 26a forms a first transverse gripping wall 26a that is perpendicular to a longitudinal axis of the shank 12.

As noted above, the tool bits need to be removably secured within the tool holder so that a tradesman or technician can remove the bit with his/her fingers, when exchanging one tool bit for another tool bit. Because of any overly tight fit, or because grease or lubricants may adhere to a user's fingers and thumb, it may be difficult to remove one tool bit and replace it with another tool bit. The addition of the first transverse gripping wall 26a serves to provide improved removability of the tool bit. In practice, the end or nail of a user's finger and thumb extends down into the exposed circumferential groove 26 and may exert an outward force against transverse gripping wall 26a in the direction of removal, allowing the bit to be more easily removed from the tool holder.

In this embodiment, reversible bit 10 has a second bit end 18 that extends from a second end of reversible bit 10. A sloped section 30 extends between shank 12 and a third circular section 32. A second exposed circumferential groove 36 is positioned adjacent the third circular section 32. Further, a fourth circular section 34 extends from the second exposed circumferential groove 36, and bit end 18 extends from the fourth circular section 34.

In this embodiment, the second exposed circumferential groove 36 has a first wall 36b formed at the intersection between the third circular section 32 and the second exposed circumferential groove 36. The second exposed circumferential groove 36 has a second wall 36a formed at the intersection between the second exposed circumferential groove 36 and the fourth circular section 22. The second wall 36a forms a second transverse gripping wall 36a that is perpendicular to a longitudinal axis of the shank 12.

As with the first transverse gripping wall 26a, the addition of the second transverse gripping wall 36a serves to provide improved removability of the tool bit. In practice, the end or nail of a user's finger or thumb extends down into the second exposed circumferential groove 36 and may exert an outward force against second transverse gripping wall 36a in the direction of removal, allowing the bit to be more easily removed from the tool holder.

FIG. 2 is a perspective view of reversible tool bit 10 shown in FIG. 1 positioned in tool holder 42 that extends from handle 40. An end of the shank and the exposed circumferential groove 26 is shown as exposed and extending from the end of tool holder 42. Thus, a user may place his/her finger and thumb into the exposed circumferential groove 26 to grasp and assist in the removal of reversible bit 10.

FIG. 3 is an exploded view of the reversible tool bit 10 shown in FIGS. 1 and 2, where reversible bit 10 is shown removed from tool holder 42 that extends from handle 40. Thus, the reversible bit 10 may be removed from the tool holder 42, and rotated 180 degrees and reinserted into the tool holder 42 to expose, and allow a user to use, second bit end 18 of the reversible bit 10.

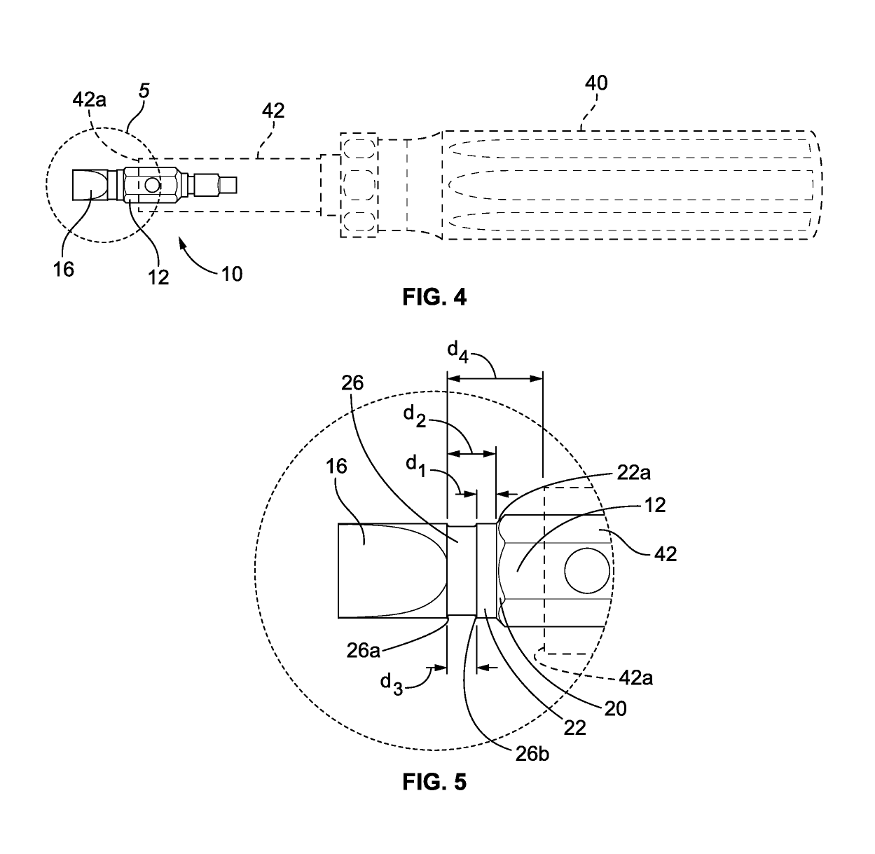

FIG. 4 is a side view of reversible bit 10 shown in FIGS. 1-3, with tool holder 42 and handle 40 shown in phantom lines. Bit end 16 and a portion of shank 12 are shown extending from a front end 42a of tool holder 42.

FIG. 5 is a close up view of circle 5 shown in FIG. 4. A portion of shank 12, sloped section 20, first circular section 22, exposed circumferential groove 26, and first bit end 16 are shown extending from front end 42a of tool holder 42. The width of exposed circumferential groove 26 is defined by the distance between first wall 26b and transverse gripping wall 26a and is defined as distance d₃. The transition point 22a is the point at which the sloped section 20 transitions to first circular section 22. The distance from transition point 22a to transverse gripping wall 26a is defined as distance d₂. The distance from transition point 22a to first wall 26b is defined by distance d₁ which is equal to the difference between d₂ and d₃. In addition, the distance from transverse gripping wall 26a to the front end 42a of tool holder 42 is defined as distance d₄.

In a preferred embodiment, the width of the exposed circumferential groove 26 is at least 1/16^{th} of an inch and the depth of the groove is at least 0.015 inches, to allow the ends of a user's finger and thumb to extend into the exposed circumferential groove 26 sufficiently to exert a force against the transverse gripping wall 26a in the direction of removal. The exposed circumferential groove 26 may have a depth larger than 0.015 inches; however, the deeper the groove, the less strength the tool bit has. Thus, there is a tradeoff between groove depth and tool bit strength, and it is been found that a groove having a depth of 0.015 provides enough depth to allow a sufficient removal force to be exerted against the transverse gripping wall 26a, without overly reducing the strength of the tool bit.

The exposed circumferential groove 26 preferably extends all of the way around the tool bit, although it is not required to. For example, the groove could be positioned only partially around the exterior of the tool bit, or have oppositely disposed arced grooves, and the term “exposed circumferential groove” would cover a groove that extends either partially or fully around the tool bit.

The sloped section 20 between the shank 12 and the first circular section 22 may serve as a finger stop 20. As a user slides his/her finger and thumb towards the shank, the finger and thumb will engage the finger stop 20 which may serve to prevent the finger and thumb from sliding over the shank. The finger stop 20 may serve to properly position the finger and thumb with respect to the location of the transverse gripping wall 26a. The distance d₂ between the transition point 22a (of the finger stop 20 to the first circular section 22) and the transverse gripping wall 26a may preferably be ⅛^{th} of an inch, although in some circumstances such as where extended shanks are used, the distance may be larger. Nonetheless, in many applications, a distance of d₂ between the transition point 22a and the transverse gripping wall 26a is advantageously around ⅛^{th} of an inch. This distance allows the fingertip to engage the finger stop and the end of the fingertip to engage and apply a force against the transverse gripping wall 26a in the direction of removal.

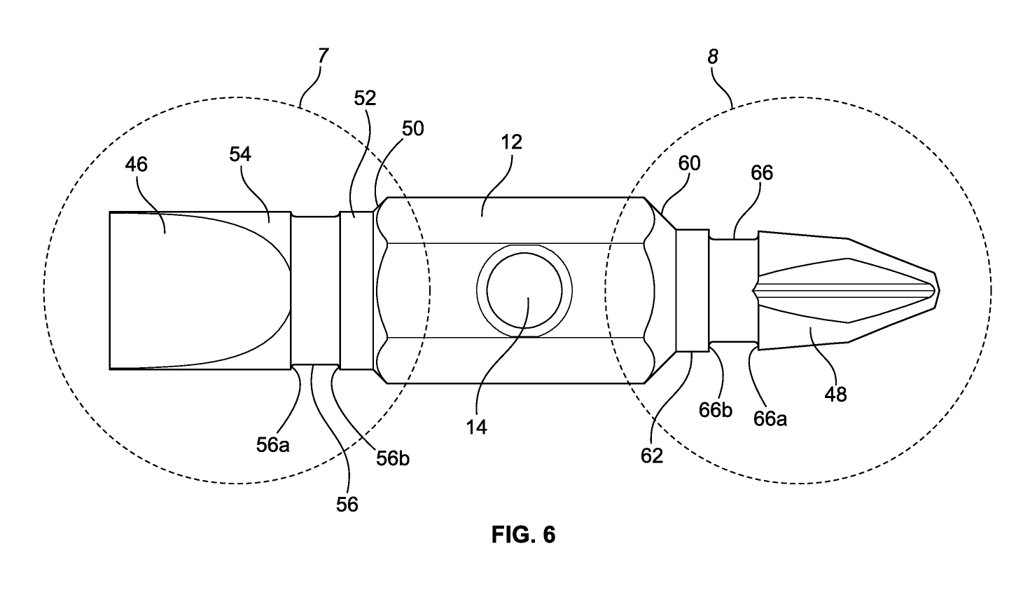

FIG. 6 shows another reversible bit with first bit end 46 and second bit end 48 extending from opposite ends of shank 12. A detent mechanism 14 is provided on shank 12 to removably secure the shank 12 within a tool holder. A sloped section 50 extends from a first end of shank 12 and may serve as a finger stop. A first circular section 52 extends from finger stop 50. An exposed circumferential groove 56 is positioned adjacent first circular section 52 and is defined by walls 56b and 56a. Wall 56a may serve as transverse gripping wall 56a. A second circular section 54 extends from the exposed circumferential groove 56, and a first bit end 46 extends from the second circular section 54. In this embodiment, the first bit end 46 is a slotted driver.

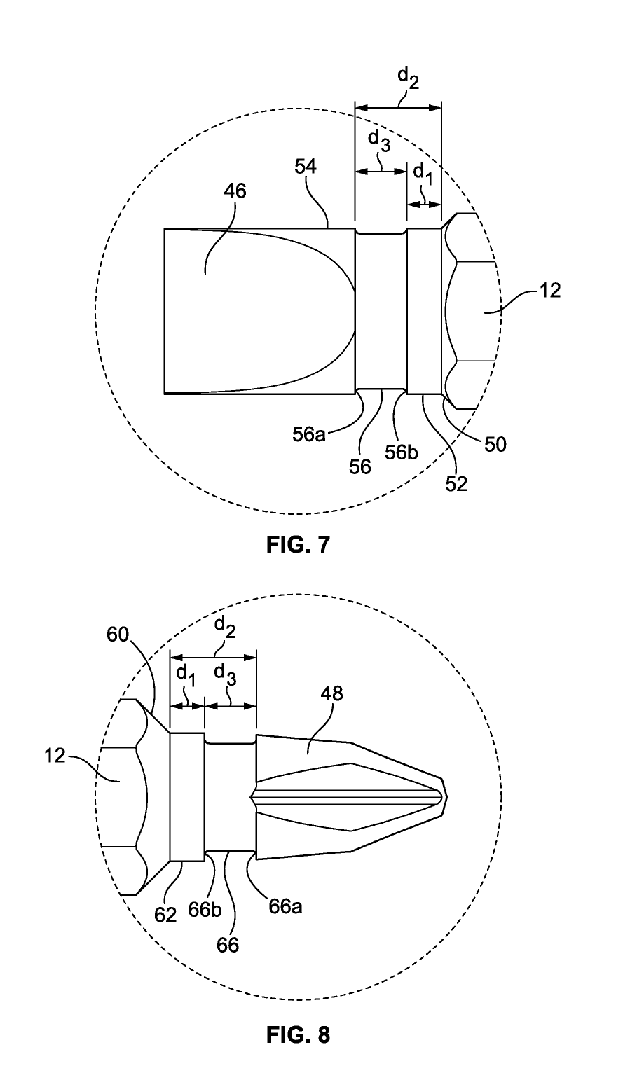

On the second end of the reversible bit, a sloped section 60 extends from the second end of shank 12 and may also serve as a finger stop. A third circular section 62 extends from finger stop 60. An exposed circumferential groove 66 is positioned adjacent third circular section 62 and is defined by walls 66b and 66a. Wall 66a may serve as transverse gripping wall 66a. A second bit end 48 extends from the exposed circumferential groove 66. In this embodiment, the second bit end 48 is a Phillips head driver. FIG. 7 is a close up view of circle 7 shown in FIG. 6. Included in FIG. 7 are a portion of shank 12, sloped section 50, first circular section 52, exposed circumferential groove 56, and first bit end 46. The width of exposed circumferential groove 56 is the distance between first wall 56b and transverse gripping wall 56a and is defined as distance d₃. The distance from the beginning of first circular section 52 (and the end of finger stop 50) to transverse gripping wall 56a is defined as distance d₂. The width of the first circular section is defined by distance d₁ which is also the distance between the end of finger stop 50 and first wall 56b.

FIG. 8 is a close up view of circle 8 shown in FIG. 6. Included in FIG. 8 are a portion of shank 12, sloped section 60, third circular section 62, exposed circumferential groove 66, and second bit end 48. The width of exposed circumferential groove 66 is the distance between first wall 66b and transverse gripping wall 66a and is defined as distance d₃. The distance from the beginning of third circular section 62 (and the end of finger stop 60) to transverse gripping wall 66a is defined as distance d₂. The width of the third circular section 62 is defined by distance d₁ which is also the distance between the end of finger stop 60 and first wall 66b.

Referring back to FIG. 1, it will be seen that the shank has a thickness which can be referred to as Dl, which is greater than the diameter D2 of first circular section 22. Thickness D1 of shank 12 may be ¼ inch and the diameter D2 of the first circular section may be 0.189 inches. As shown in FIG. 1, the diameter of the third circular section 32 may be equal to the diameter of the first circular section 22.

Referring back to FIGS. 6-8, it will be seen that in this embodiment, the diameter D2 of first circular section 52 is greater than the diameter D3 of the exposed circumferential groove 56. In this embodiment the diameter D2 of the first circular section 52 is greater than the diameter D4 of the third circular section 62. In a preferred embodiment the thickness D1 of shank 12 is ¼ inches, the diameter D2 of the first circular section 52 is 0.239 inches, and the diameter D4 of the third circular section 62 is 0.185 inches. Further, in a preferred embodiment, the width of the exposed circumferential grooves 56 and 66 is at least 1/16^{th} of an inch and the depth of the grooves is at least 0.015 inches, to allow the end or nail of a user's finger and thumb to extend into the exposed circumferential groove 26 sufficiently to exert a force against the transverse gripping wall 56a or 66a in the direction of removal. The exposed circumferential grooves 56 and 66 may have a depth larger than 0.015 inches; however, the deeper the groove, the less strength the tool bit has. Thus, there is a tradeoff between groove depth and tool bit strength, and it is been found that a groove having a depth of 0.015 provides enough depth to allow a sufficient removal force to be exerted against the transverse gripping walls 56a and 66a, without overly reducing the strength of the tool bit.

The exposed circumferential groove 26 preferably extends all of the way around the tool bit, although it is not required to. For example, the groove could be positioned only partially around the exterior of the tool bit, or have oppositely disposed arced grooves, and the term “exposed circumferential groove” would cover a groove that extends either partially or fully around the tool bit.

It will be appreciated that the term “circular section” as used herein is to be interpreted broadly and does not require a strictly circular cross section. In fact, a rounded or oval cross section is considered a “circular section” as that term is used herein.

In FIGS. 6 and 7, the sloped section 50 between the shank 12 and the first circular section 52 may serve as a finger stop 50. As a user slides his/her finger and thumb towards the shank, the finger and thumb will engage the finger stop 50 which may serve to prevent the finger and thumb from sliding over the shank. The finger stop 50 may serve to properly position the finger and thumb with respect to the location of the transverse gripping wall 56a. The distance d₂ between the end of the finger stop 50 and the transverse gripping wall 56a may preferably be ⅛^{th} of an inch, although in some circumstances such as where extended shanks are used, the distance may be larger. Nonetheless, in many applications, a distance of d₂ is advantageously around ⅛^{th} of an inch. This distance allows the fingertip to engage the finger stop 50 and the end of the fingertip to engage and apply a force against the transverse gripping wall 56a in the direction of removal.

There a number of reasons why it may be advantageous to provide a first circular section between the end of the finger stop and the exposed circumferential groove. First, the use of a first circular section having a diameter D2 that is less than the thickness Dl of the shank, allows for the creation of a finger stop that extends continuously around the circumference of the reversible bit. Further, the use of a first circular section having a diameter D2 that is less than the thickness D1 of the shank but greater than the diameter D3 of the exposed circumferential groove provides for a less severe transition from the thickness of the shank to the diameter of the groove, reducing the stress concentrations that could be formed in the reversible bit. In effect, the first circular section provides a tapered or step-wise transition from the thickness of the shank to the diameter of the groove. This in turn also provides greater strength to the tool than if there was an abrupt transition from thickness D1 of the shank to diameter D3 of the exposed circumferential groove. In a preferred embodiment the width of the first circular section is at least 1/16^{th} of an inch. In addition, the first circular section and the second circular section are not required to have the same diameter throughout their width, and could be tapered as an example.

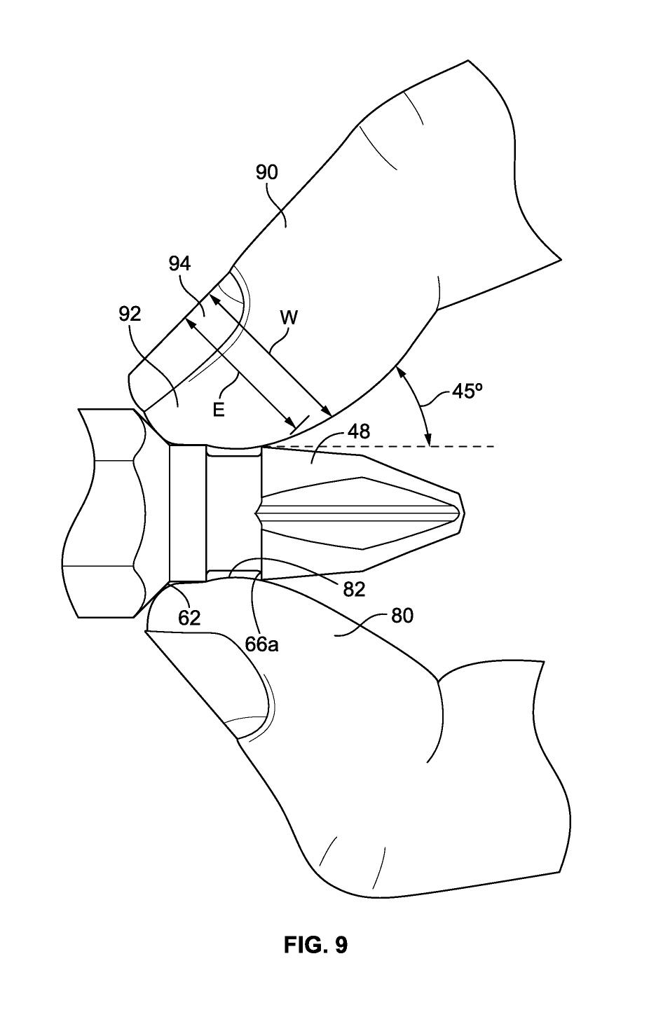

FIG. 9 is a side view of a tool bit showing the fingertip 90 of a user contacting finger stop 62 of the bit and an end of the fingertip in engagement with transverse gripping wall 66a, as well as an end 82 of thumb 80 in engagement with transverse gripping wall 66a. In this example, the fingertip is positioned at an angle of 45 from the longitudinal axis of the shank 12. The distance d₂ from the end of the finger stop 62 to the transverse gripping wall 66a is shown in FIG. 8. In FIG. 9, the end of fingertip 90 is engaged with finger stop 62. The width of fingertip 90 is defined as W. An end 92 of fingertip 90 is defined as the portion of fingertip 90 that has a thickness that is smaller than a thickness E that is 85% or less of width W. Thus, as shown in FIG. 9, the end 92 of fingertip 90 is that portion of the fingertip that is shown to the left of line E. Therefore, in FIG. 9, when the fingertip 92 is engaged with finger stop 62, the distance d₂ (from the end of finger stop 62 to transverse gripping wall 66a) is such that an end 92 of fingertip 90 is engaged with transverse gripping wall 66a. If the distance d₃ was much longer, then the end 92 of fingertip 90 would not engage the transverse gripping wall 66a when the end of fingertip 90 is engaged with finger stop 62. In a preferred embodiment, the distance d₂ is ⅛ of an inch. In addition, end 82 of thumb 80 is also shown in engagement with finger stop 62. Thus, in this embodiment, both the end of the fingertip and the end 82 of the thumb 80 engage finger stop 62. However, in other embodiments, the end of the fingertip and/or the end 82 of the thumb 80 may not engage the finger stop 62 in the removal process.

In the above Figures, the transverse gripping wall is perpendicular to the longitudinal axis of the shank, as a right angle is formed at the transition between the exposed circumferential groove and the second circular section. It will be appreciated that the term “perpendicular” and “right angle” does not require an exactly 90 degree angle. In particular, the base of the transverse gripping wall could be rounded at the interface with the end of the exposed circumferential groove to reduce stress concentrations in the tool. Moreover, the reversible bit could be a cast or molded piece such that draft angles are used to allow for release of the parts. Thus, the term “perpendicular” or “right angle” will encompass deviations up to 10 degrees or so. However, it would not encompass an angle as high as 30 degrees, as the finger or thumb could too easily slip off the transverse gripping wall if an angle as high as 30 degrees was used.

Example embodiments have been described above. Those skilled in the art will understand that changes and modifications may be made to the described embodiments without departing from the true scope and spirit of the present invention, which is defined by the claims.

I claim:

1. A tool bit comprising:
a shank having a hexagonal cross-section adapted to be removably positioned within a tool for rotating the shank, the shank having a thickness D1;
a first circular section extending from a first end of the shank, the first circular section having a diameter D2, where D2 is less than D1;
an exposed circumferential groove positioned adjacent the first circular section, where the exposed circumferential groove has a diameter D3 which is less than diameter D2;
a second circular section having an outer surface extending from the circumferential groove;
a first bit end extending from the second circular section; and
wherein a right angle is formed at the transition of the circumferential groove to the outer surface of the second circular section forming a first transverse gripping wall that is perpendicular to a longitudinal axis of the shank.

2. The tool bit of claim 1, wherein the width of the exposed circumferential groove is at least 1/16 inch.

3. The tool bit of claim 1, wherein the depth of the exposed circumferential groove is at least 0.015 inches.

4. The tool bit of claim 1, wherein the second circular section has a diameter that is equal to D2.

5. The tool bit of claim 2, wherein the depth of the exposed circumferential groove is 0.015 inches.

6. The tool bit of claim 3, wherein the width of the exposed circumferential groove is 1/16 inch.

7. The tool bit of claim 1, where D1 is ¼ inch.

8. The tool bit of claim 7, wherein D2 is between 0.185 inches and 0.239 inches inclusive.

9. The tool bit of claim 8, wherein D2 is 0.185 inches

10. The tool bit of claim 8, wherein D2 is 0.239 inches.

11. The tool bit of claim 8, wherein the depth of the exposed circumferential groove is at least 0.015 inches.

12. The tool bit of claim 8, wherein the width of the exposed circumferential groove is 1/16 of an inch.

13. The tool bit of claim 11, wherein the width of the exposed circumferential groove is 1/16 of an inch.

14. The tool bit of claim 13, further including a downwardly extending finger stop positioned between the end of the shank and the first circular section and the transverse gripping wall is positioned a distance d2 from the end of the finger stop.

15. The tool bit of claim 14, wherein the distance d2 is ⅛ of an inch.

16. The tool bit of claim 1, further including a first downwardly extending finger stop positioned between the first end of the shank and the first circular section.

17. The tool bit of claim 16, wherein the first transverse gripping wall is positioned a distance d2 from the end of the first finger stop.

18. The tool bit of claim 17, wherein the distance d2 is ⅛ of an inch.

19. The tool bit of claim 17, wherein the distance d2 is such that when a fingertip of a user with an end of the finger that is ¼ inch thick engages the first finger stop with the fingertip angled at a 45 degree angle, the end of the fingertip engages the first transverse gripping wall.

20. The tool bit of claim 1, further including a third circular section extending from a second end of the shank, the third circular section having a diameter D4, where D4 is less than D1;
a second exposed circumferential groove positioned adjacent the third circular section, where the exposed circumferential groove has a diameter D3 which is less than diameter D4;
a fourth circular section having an outer surface extending from the second circumferential groove;
a second bit end extending from the fourth circular section; and
wherein a right angle is formed at the transition of the second circumferential groove to the outer surface of the fourth circular section forming a second transverse gripping wall that is perpendicular to a longitudinal axis of the shank.

21. The tool bit of claim 20, further including a downwardly extending finger stop positioned between the second end of the shank and the third circular section.

22. The tool bit of claim 21, wherein the second transverse gripping wall is positioned a distance d4 from the end of the finger stop.

23. The tool bit of claim 22, wherein the distance d4 is ⅛ of an inch.

24. The tool bit of claim 22, wherein the distance d4 is such that when a fingertip of a user with an end of the finger that is ¼ inch thick engages the finger stop with the fingertip angled at a 45 degree angle, the end of the fingertip engages the second transverse gripping wall.

25. The tool bit of claim 20, wherein the width of the second exposed circumferential groove is 1/16 inch wide.

26. The tool bit of claim 20, wherein the depth of the second exposed circumferential groove is at least 0.015 inches.

27. The tool bit of claim 26, wherein the depth of the second exposed circumferential groove is 0.015 inches.

28. The tool bit of claim 20, wherein D2 and D4 are each between 0.185 and 0.239 inches inclusive.

29. The tool bit of claim 28, wherein D2 is 0.185 inches and D4 is 0.239 inches.

30. A tool bit comprising:
a shank having a hexagonal cross-section adapted to be removably positioned within a tool for rotating the shank, the shank having a thickness D1;
a first circular section extending from a first end of the shank, the first circular section having a diameter D2, where D2 is less than D1;
a second circular section extending from the first circular section, the second circular section having a diameter D3, where D3 is less than D1 and greater than D2;
a first bit end extending from the second circular section; and
wherein a right angle is formed at the transition of the first circular surface and the second circular surface forming a first transverse gripping wall that is perpendicular to a longitudinal axis of the shank.

31. The tool bit of claim 30, further including a first downwardly extending finger stop positioned between the first end of the shank and the first circular section.

32. The tool bit of claim 31, wherein the first transverse gripping wall is positioned a distance d2 from the end of the first finger stop.

33. The tool bit of claim 32, wherein the distance d2 is ⅛ of an inch.

34. The tool bit of claim 32, wherein the distance d2 is such that the when a fingertip of user with an end of the finger that is ¼ inch thick engages the first finger stop with the fingertip angled at a 45 degree angle, the end of the fingertip engages the first transverse gripping wall.

35. The tool bit of claim 30, wherein the difference in diameter between D2 and D3 is at least 0.030 inches.
